(19) United States
(12) Patent Application Publication
(10) Pub. No.: US 2007/0085254 A1
(43) Pub. Date: Apr. 19, 2007

(54) Wheel removal aid

(76) Inventor: David Kaleel, Lorain, OH (US)

Correspondence Address: LINDON & LINDON, 1250 LINDA STREET, ROCKY RIVER, OH, 44116, US

(21) Appl. No.: 11/248,793

(22) Filed: Oct. 13, 2005

(51) Int. Cl. B23Q 3/00

(52) U.S. Cl. 269/17; 157/14

(57) ABSTRACT

A device for moving a tire assembly. The device has a first roller and a second roller operatively connected to a frame. The device has a third roller operatively connected to the frame. The first roller and the second roller are positioned generally parallel to each other and generally perpendicular to the third roller.

### BACKGROUND OF THE INVENTION

Modern motor vehicles employ relatively heavy wheels and tires—also known as tire assemblies. While these wheels and tires are useful to produce a relatively smooth ride, they can be difficult to remove from or position onto the vehicles when the tires go flat or need to be replaced. Many tires wear and/or go flat, and periodically need to be removed and replaced by a fresh tire.

Traditionally, replacing a flat tire required removing the nuts from the bolts on the hub, using a jack to selectively lift the vehicle and tire assembly, then lifting the tire assembly off the bolts on the hub. This is difficult because the tire assembly is heavy. Then, a fresh tire assembly is positioned back onto the hub. This is difficult because holes in the heavy tire assembly must be aligned with the bolts on the hub. The vehicle is then selectively lowered so that the tire assembly is back on the ground. Finally, the nuts are placed back onto the bolts on the hub.

Because the wheels and tires are heavy, removing and/or replacing them can be problematic. There is a long-felt need for an aid for wheel removal and/or replacement.

### SUMMARY OF THE INVENTION

The above advantages as well as other advantages not specifically enumerated are achieved by a device for moving a tire assembly. The device has a first roller and a second roller operatively connected to a frame. The device has a third roller operatively connected to the frame. The first roller and the second roller are positioned generally parallel to each other and generally perpendicular to the third roller.

Various advantages of this invention will become apparent to those skilled in the art from the following detailed description of the preferred embodiment, when read in light of the accompanying drawings.

### BRIEF DESCRIPTION OF THE DRAWINGS

FIG. 1 is an top plan perspective view of a device for changing a tire in accordance with the present invention.

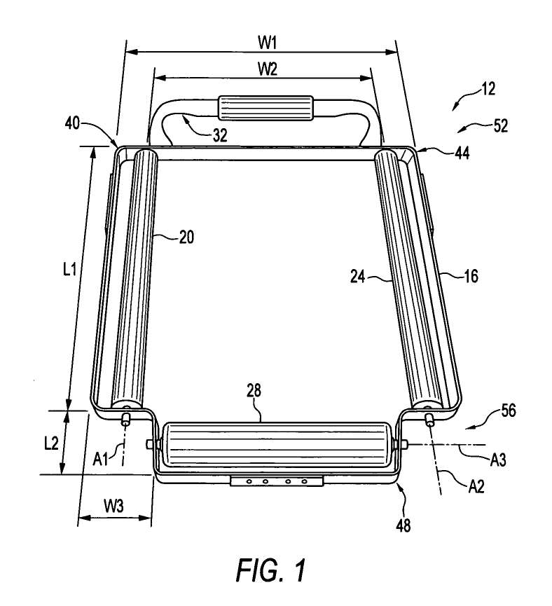

FIG. 2 is an front end view of the device of FIG. 1.

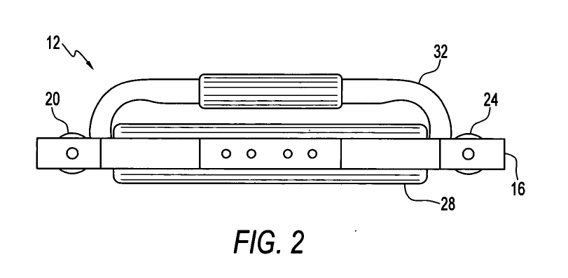

FIG. 3 is an elevational side view of the device of FIG. 1 positioned generally under a tire assembly next to an automobile, with the device generally resting on the third roller of the device.

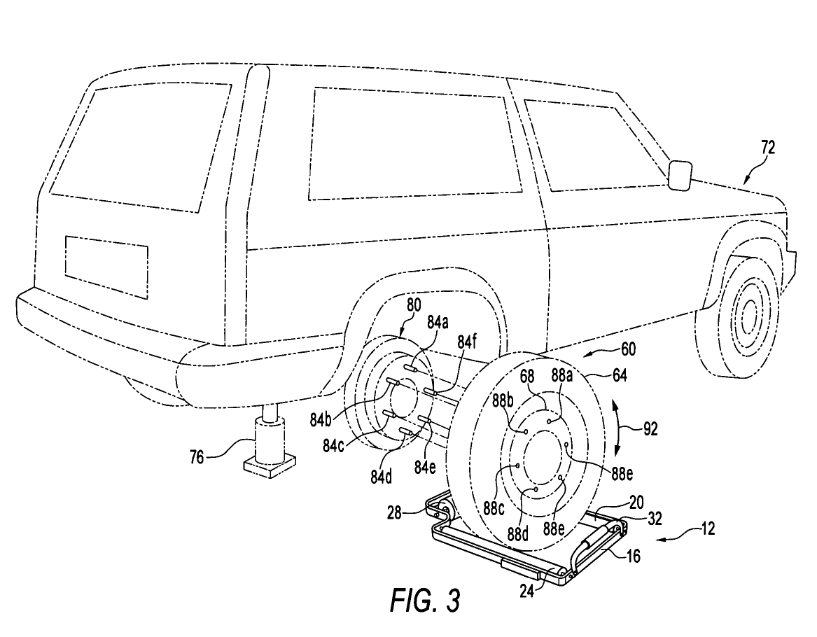

### DETAILED DESCRIPTION

This application claims the benefit of U.S. Provisional Application No. 60/679,866, filed May 12, 2005.

Preliminarily, it should be noted that certain directional terms that may be used herein are used to facilitate the description of the invention. Unless otherwise specified or made apparent by the context of the discussion, such terms and the like should be interpreted with reference to the figure(s) under discussion. Such terms are not intended as a limitation on the position in which the invention or components may be used. Indeed, it is contemplated that the components of the invention may be easily positioned in any desired orientation for use. Likewise, numerical terms such as for example “first” and “second” are not intended as a limitation or to imply a sequence, unless otherwise specified or made apparent by the context of the discussion.

Referring now to the drawings, there is illustrated a device, indicated generally at 12, in accordance with the present invention. A number of terms may be clarified to facilitate understanding of the invention. The term “operatively connected” is understood to include a linking together of the portions under consideration and may include a physical engagement and/or a functional or operational connection. The term “wheel” is understood to include a circular frame of relatively hard material that may be solid, partly solid, and/or spoked and that may be generally capable of turning on an axle. The term “tire” use herein is understood to include a cushion, often rubber, that fits around a wheel (as of an automobile) and often contains compressed air. When the notion of changing, removing, and/or replacing a tire is discussed herein, it is generally understood to include both the tire and the wheel unless otherwise made clear by the context. The term “tire assembly” is generally understood to include a wheel and a tire operatively connected.

The device 12 may be employed to remove a tire assembly 60 from an automobile 72. The device 12 may also be employed to replace and/or position a tire assembly 60 onto an automobile 72. The illustrated device 12 includes a frame 16, a first roller 20, a second roller 24, a third roller 28, and a handle 32. The term “frame” may be understood to include a generally supporting structure that may include parts and has something built around or on it. The first roller 20, the second roller 24, and the third roller 28 are operatively connected to the frame 16. The term “roller” may be understood to include a generally cylindrical and/or rod-like structure over which or on which something is generally moved and/or positioned. The cylinder and/or rod-like structure may be provided to selectively rotate about a central axis. The first roller 20, the second roller 24, and the third roller 28 are shown rotatably connected to the frame 16.

The illustrated frame 16 includes a first seat 40 for the first roller 20, a second seat 44 for the second roller 24, and a third seat 48 for the third roller 28. The term “seat” may be understood to include a place where something specified is located. The term “seat” may also be understood to include a part and/or surface on or in which another component or surface rests. The first seat 40 and the second seat 44 include a first length L1. It will be noted that the first roller 20 and the second roller 24 generally span the first length L1. The first roller 20 is mounted for rotation within the first seat 40. The second roller 24 is mounted for rotation within the second seat 44. The third roller 28 is mounted for rotation within the third seat 48.

The handle 32 is located at a first end 52 of the device 12. The third roller 28 is located at a second end 56 of the device 12. The illustrated first seat 40 and the illustrated second seat 44 are generally indented from the second end 56 of the device 12 by a second length L2. The frame 16, and any portion thereof, may be constructed to any suitable length(s). The first roller 20 is rotatable on a first axis A1. The second roller 24 is rotatable on a second axis A2. The third roller 28 is rotatable on a third axis A3.

The illustrated frame 16 is constructed at a first width W1. The first axis A1 and the second axis A2 are spaced apart by a second length. The widths of the illustrated first seat 40 and the illustrated second seat 44 are constructed at a first width W3. The frame 16, and any portion thereof, may be constructed to any suitable width(s).

In operation, the device 12 may be employed to selectively locate and/or position a tire assembly 60. The illustrated tire assembly 60 includes a tire 64 and a wheel 68. The tire assembly 60 is shown in relation to a prior art automobile 72. The illustrated automobile 72 is shown selectively lifted by a jack 76. The illustrated automobile 72 includes a hub 80 having six threaded bolts 84a,b,c,d,e,f. The illustrated wheel 68 includes six corresponding holes 88a,b,c,d,e,f to cooperate with the six threaded bolts 84a,b,c,d,e,f. The device 12 may be employed with any suitable tire assembly 60 and automobile 72.

The third roller 28 is useful to selectively locate and move the tire assembly 60 toward the automobile 72 and away from the automobile 72. The tire assembly 60 rests on the device 12 while the device 12 selectively moves on the rotating third roller 28. The first end 52 of the device 12 can be selectively lifted and/or lowered by the handle 32, and thereby selectively elevate and/or lower the tire assembly 60. When the device 12 is selectively lifted and/or lowered by the handle 32, the frame 16 defines an acute angle with the surface on which the tire assembly 60 of the automobile 72 generally rest.

The first roller 20 and the second roller 24 are useful to allow the tire assembly 60 to be selectively rotated to align the holes 88a,b,c,d,e,f in the wheel 68 with the threaded bolts 84a,b,c,d,e,f. As indicated by the arrow 92, selective rotation of the tire assembly 60 is facilitated by the rotatably mounted first roller 20 and the rotatably mounted second roller 24. The device 12 allows for a more convenient one-person (not shown) replacement of a tire assembly 60. By way of example, the handle 32 of the device 12 can be selectively lifted or lowered by a person's left hand (not shown), while the tire assembly 60 resting on the first roller 20 and the second roller 24 can be selectively rotated as indicated by the arrow 92 by a person's right hand (not shown). While the tire assembly 60 is being selectively rotated indicated by the arrow 92, much of the weight of the tire assembly 60 is substantially supported by the third roller 28. The third roller 28 may be rotatably mounted as shown.

It will be appreciated that, while the tire assembly 60 is being selectively lifted and/or lowered, the third roller 28 of the device 12 is preferably in contact with the road or other surface supporting the automobile 72. It will be appreciated that, while the tire assembly 60 is being selectively rotated generally clockwise and/or generally counter clockwise, the third roller 28 of the device 12 is preferably in contact with the road or other surface supporting the automobile 72. It will be appreciated that the illustrated first roller 20 and the illustrated second roller 24 are positioned generally parallel to each other and generally perpendicular to the third roller 28.

It will be noted that the first roller 20, the second roller 24, and the third roller 28 are bearings. The term “bearings” is understood to include a suitable structure or element which can support the weight of an object. The first roller 20 and the second roller 24 are bearings to facilitate positioning and/or rotation of the tire assembly 60. The third roller 28 is a bearing to facilitate generally horizontal and/or lateral movement and/or elevation of the tire assembly 60. The third roller 28 is a bearing to facilitate movement of the frame 16.

Alternate embodiments may be contemplated. A plurality or series of generally concentric wheels may be used in place of the first roller 20 and/or the second roller 24. The generally concentric wheels may be placed generally side-by-side to allow the tire assembly 60 to rest thereon and selectively rotated as indicated by the arrow 92. The wheels may be placed on the first axis A1 and the second axis A2 as desired. A plurality or series of generally concentric wheels may be used in place of the third roller 28. The generally concentric wheels may be placed generally side-by-side to allow the tire assembly 60 to be selectively moved toward and/or away from the automobile 72. The generally concentric wheels may be placed on the third axis A3 as desired. The frame 16 may also be foldable and/or collapsible for ready storage.

In operation, the device 12 may be employed to remove a tire assembly 60 from an automobile 72. One or more of the following steps may be employed to do so. The automobile 72 is stopped. The nuts are loosened and/or removed from the threaded bolts 84a,b,c,d,e,f on the hub 80 that extend through the wheel 68 of the desired tire assembly 60. A desired portion of the automobile 72 may be selectively raised, or “jacked up” with a jack 76, thereby generally raising the desired tire assembly 60. The elevation of the tire assembly 60 is changed with the device 12. The device 12 is positioned generally under the desired tire assembly 60. The tire assembly 60 and the device 12 come into contact. The first roller 20 and the second roller 24 of the device 12 generally contact the tire 64 of the tire assembly 60. The first end 52 of the device 12 may be selectively lifted and/or lowered by the handle 32, and thereby selectively elevate and/or lower the tire assembly 60. The third roller 28 of the device 12 may selectively move the tire assembly 60 toward the automobile 72 and away from the automobile 72 as desired. When the tire assembly 60 is sufficiently away from the automobile 72, the tire assembly 60 is removed from s the device 12.

In operation, the device 12 may be employed to place and/or replace a tire assembly 60 onto an automobile 72. One or more of the following steps may be employed to do so. A desired portion of the automobile 72 may be selectively positioned with a jack 76 or other suitable raising means and/or lowering means. The tire assembly 60 is placed on the device 12. The first end 52 of the device 12 may be selectively lifted and/or lowered by the handle 32, and thereby selectively elevate and/or lower the tire assembly 60. The third roller 28 of the device 12 may selectively move the tire assembly 60 toward the automobile 72 and away from the automobile 72 as desired. The tire assembly 60 is selectively rotated on the first roller 20 and the second roller 24 of the device 12. The holes 88a,b,c,d,e,f on the wheel 68 are generally aligned with the threaded bolts 84a,b,c,d,e,f on the hub 80. The wheel 68 of the tire assembly 60 is placed on the hub 80. The tire assembly 60 is generally lowered by the handle 32 of the device 12. The nuts are placed onto the threaded bolts 84a,b,c,d,e,f on the hub 80. The device 12 is moved out from under the automobile 72 via the third roller 28.

It is to be understood that the invention is not limited in its application to the details of construction and to the arrangements of the components set forth in the accompanying description or illustrated in the drawings. The invention is capable of other embodiments and of being practiced and carried out in various ways. Also, it is to be understood that the phraseology and terminology employed herein are for the purpose of description and should not be regarded as limiting. The disclosure may readily be utilized as a basis for the designing of other structures, methods and systems for carrying out the present invention. It is important, therefore, that the claims be regarded as including equivalent constructions. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract and disclosure are neither intended to define the invention of the application, which is measured by the claims, nor are they intended to be limiting as to the scope of the invention in any way.

What is claimed is:

1. A device for moving a tire assembly comprising:
a first roller and a second roller operatively connected to a frame; and
a third roller operatively connected to the frame,
wherein the first roller and the second roller are positioned generally parallel to each other and generally perpendicular to the third roller.

2. The device of claim 1 wherein the first roller and the second roller are generally cylindrical and are rotatably mounted to the frame.

3. The device of claim 1 wherein the frame has a first end and a second end and the first roller and the second roller extend generally between the first end and the second end of the frame.

4. The device of claim 1 wherein the third roller has a diameter larger than the diameter of the first roller and the second roller.

5. The device of claim 1 wherein the frame is generally indented to support the third roller.

6. The device of claim 1 wherein the first roller and the second roller are about the same length.

7. The device of claim 6 wherein the first roller and the second roller are rotatably mounted to the frame.

8. The device of claim 7 wherein the third roller has a diameter larger than the diameter of the first roller and the second roller.

9. The device of claim 1 further comprising a handle wherein the handle is located at a first end of the device and the third roller is located at a second end of the device.

10. The device of claim 9 wherein the first end of the device and the second end of the device are generally separated by the first roller and the second roller.

11. A method of using a device for removing a tire assembly from an automobile comprising:
providing the device having a first roller and a second roller and a third roller operatively connected to a frame;
positioning the device generally under the tire assembly, wherein the tire assembly contacts the first roller and the second roller on the device;
selectively changing the elevation of the tire assembly with the device; and
selectively moving the device generally away from the automobile on the third roller.

12. The method of claim 11 wherein the first roller and the second roller and the third roller are generally cylindrical.

13. The method of claim 11 wherein the frame has a first end and a second end and the first roller and the second roller extend generally between the first end and the second end of the frame.

14. The method of claim 11 wherein the third roller has a diameter larger than the diameter of the first roller and the second roller.

15. The method of using a device for positioning a tire assembly onto an automobile comprising:
providing the device having a first roller and a second roller and a third roller operatively connected to a frame;
positioning the tire assembly onto the device;
moving the device toward the automobile generally on the third roller of the device;
selectively changing the elevation of the tire assembly with the device; and
selectively rotating the tire assembly on the first roller and the second roller.

16. The method of claim 15 wherein the first roller and the second roller and the third roller are generally cylindrical.

17. The method of claim 15 wherein the frame has a first end and a second end and the first roller and the second roller extend generally between the first end and the second end of the frame.

18. The method of claim 15 wherein the third roller has a diameter larger than the diameter of the first roller and the second roller

19. The method of claim 15 wherein the first roller and the second roller are rotatably mounted to the frame.

20. The method of claim 15 wherein the first roller and the second roller and the third roller are rotatably mounted to the frame.
